(19) United States
(12) Patent Application Publication
(10) Pub. No.: US 2016/0242882 A1
(43) Pub. Date: Aug. 25, 2016

(54) STAR-SHAPED MICROFIBER DENTAL FLOSS WITH NODULES

(71) Applicant: Shawn Stuart, Salt Lake City, UT (US)

(72) Inventor: Shawn Stuart, Salt Lake City, UT (US)

(21) Appl. No.: 15/050,654

(22) Filed: Feb. 23, 2016

Related U.S. Application Data
(60) Provisional application No. 62/119,375, filed on Feb. 23, 2015.

(51) Int. Cl. A61C 15/04; A61C 19/06

(52) U.S. Cl. CPC A61C 15/046; A61C 15/041; A61C 19/063

(57) ABSTRACT

The present invention provides a dental flossing apparatus that includes one or more star-shaped microfiber stands with two nodules and one or more optional therapeutic agents. Method of using the dental flossing apparatus to deliver one or more optional therapeutic agents to the teeth and gums are also provided.

### RELATED APPLICATIONS

This application claims priority to U.S. Provisional Patent Application Ser. No. 62/119,375 filed Feb. 23, 2015, which is hereby incorporated by reference in its entirety for all purposes.

### BACKGROUND OF THE INVENTION

Dental floss is used to remove food particles lodged in the areas between the teeth. Typically, a user cuts off a section of dental floss from the dispenser. The user passes the dental floss between two adjacent teeth and moves the dental floss back and forth to dislodge food particles trapped therein, which are acted upon by bacteria to create plaque. As a result, the plaque buildup between the teeth is greatly reduced leading to cleaner teeth and less gum disease.

Conventional dental floss is typically a single smooth, sometimes waxed, elongated strand having uniform dimensions. This makes it difficult for the user to hold the floss during use because the dental floss cannot be tightly grasped and it slips between the user's fingers. Such smooth, uniform floss also does not function well to clean the surfaces on the teeth and does not remove very well the unwanted material dislodged from interproximal regions between the teeth, and does nothing to capture and remove the bacteria present there. Further, the single smooth, sometimes waxed, elongated strand does not absorb therapeutic agents to allow for the delivery of those therapeutic agents to the interproximal regions between the teeth.

What is needed is a dental floss that is easily held, effectively cleans the surfaces of the teeth, removes the dislodged debris, captures and removes the bacteria present, and applies therapeutic agents to the interproximal regions between the teeth.

### SUMMARY OF THE INVENTION

The present invention provides a dental flossing apparatus that includes one or more star-shaped microfiber stands with two nodules and one or more optional therapeutic agents. Method of using the dental flossing apparatus to deliver one or more optional therapeutic agents to the teeth and gums are also provided.

Unlike conventional dental floss, the star-shaped microfiber strands absorb and hold about seven times its weight in liquid, much more than natural fibers such as cotton. Thus, the dental flossing apparatus can administer much more therapeutic agent than natural fibers or the typical non-absorbent and sometimes waxed dental floss. Further, the consumer can choose from any number of therapeutic agents and can control the amount of the agent that is applied directly between the teeth and gums. The novel dental flossing apparatus has the following advantages.

First, the nodules are integrally manufactured along the strand of floss to facilitate handling. These nodules eliminate the waste and discomfort associated with having to wrap the floss around one's fingertips. Approximately 50% of regular dental floss is discarded without ever touching a tooth because it is wrapped around a finger in order to make the other 50% manageable. The nodules also eliminate the need for devices that have been invented to avoid the necessity of wrapping the floss around a finger, for example, rings to which the floss must be tied and plastic yokes. The plastic yokes resemble a wishbone across the gap of which the floss is either tied or manufactured in place. This is the most wasteful of all options, producing 3 inches of plastic waste for every 1 inch of floss used it also reduces the feel when controlling the floss that comes from one's fingertips actually touching the floss as it is guided between the teeth and gums. The prior art (U.S. Pat. No. 6,112,753) describes floss with very small protuberances closely packed together to afford the user some traction while gripping the floss with the fingers. In contrast, the nodules of the present invention serve an entirely different function, being comparatively large and over three, preferably six inches apart. They allow the user to catch the nodule between and against the back of the two middle fingers, which frees the index finger and thumb to work the floss without the possibility of it slipping between them.

Second, the star-shaped microfiber increases the effectiveness of the floss significantly. The star-shaped microfiber floss doesn't just dislodge food particles and plaque, leaving them in one's mouth, as regular flosses do. Rather, the star-shaped microfiber works on a microscopic level to actually glom onto, not only food particles and plaque, hut also bacteria, and to remove them from the mouth to be discarded with the floss.

Third, the multi-strand design of star-shaped microfiber floss makes the microfiber's inherent proclivity to glom onto microscopic particles, for example, bacteria, viruses and bits of food, even more effective by allowing the individual strands to work together by attaching themselves to a given particle from more than one side, as a single strand of star-shaped microfiber would do. This multi-strand design also facilitates the positioning of the floss between the teeth in two ways. If the teeth are tightly packed, the several strands of microfiber tend to align themselves one after the other in single file, which allows them to slip more easily between the teeth than one thicker strand would. If, however, the teeth are too tightly packed, the user may twist the several strands into one tighter, stronger strand, as needed, to force the star-shaped microfiber floss between the tightly packed teeth without breaking the floss. In both scenarios, once between the teeth the star-shaped microfiber floss can relax and expand back to its normal multi-strand configuration to be most effective in cleaning.

Finally, the star-shaped microfiber floss absorbs about seven times its own weight in liquid, much more than cotton, and regular waxed or unwaxed dental floss, allowing the star-shaped microfiber floss to be used to administer therapeutic agents in far greater quantities directly between the teeth and gums. Additionally, the star-shaped microfiber floss comes untreated with any therapeutic agent, but ready to absorb and transfer whatever therapeutic agent the consumer may desire directly to the area between the teeth and gums. This is accomplished by dipping the star-shaped microfiber floss in the desired agent and flossing normally.

The present invention provides a dental flossing apparatus. The dental flossing apparatus includes: one or more star-shaped microfiber dental floss strands; and two or more nodules coupled to and spaced along the one or more star-shaped microfiber dental floss strands.

In one embodiment, the one or more star-shaped microfiber dental floss strands each independently include one or more star-shaped microfiber yarns. In one embodiment, the one or more star-shaped microfiber dental floss strands each independently include a polyester polyamide fiber. In one embodiment, the one or more star-shaped microfiber dental floss strands each independently have a thickness from about 50D/436F*16 to about 320D/144F*16.

In one embodiment, the two or more nodules are equally spaced along the one or more star-shaped microfiber dental floss strands. In one embodiment, the two or more nodules are spaced at least six inches apart along the one or more star-shaped microfiber dental floss strands.

In one embodiment, the diameter of the two or more nodules is from about 0.5 mm to about 8.0 mm, preferably about 2 mm to about 6 mm. In one embodiment, the two or more nodules are each independently spherically-shaped, elliptically-shaped, square-shaped, star-shaped, rectangular-shaped, triangularly-shaped, irregularly-shaped, or a combination thereof.

In one embodiment, the two or more nodules are each independently coupled to each of the one or more star-shaped microfiber strands by having the one or more star-shaped microfiber strands extend through a cavity in the two or more nodules.

In one embodiment, the two or more nodules are each independently hot-melted to the one or more star-shaped microfiber strands. In one embodiment, the two or more nodules are each independently glued to the one or more star-shaped microfiber strands.

In one embodiment, the two or more nodules each independently include a plastic, a wax, a metal, a wood, a composite material, or a combination thereof. In one embodiment, the plastic includes a polylactic acid.

In one embodiment, the one or more star-shaped microfiber dental floss strands each independently further include one or more therapeutic agents. In one embodiment, the one or more therapeutic agents each independently include hydrogen peroxide, tea tree oil, one or more probiotic gum oils, one or more essential oils, chlorhexidine gluconate, or a combination thereof.

In one embodiment, the dental flossing apparatus is a spool of dental flossing apparatus.

The present invention provides a dental flossing apparatus. The dental flossing apparatus includes: one or more star-shaped microfiber dental floss strands; two or more nodules coupled to and spaced along the one or more star-shaped microfiber dental floss strands, and with the proviso that the one or more nodules are not of a size and shape that minimizes the possibility of damaging the gums of a user of the dental flossing apparatus, and the one or more nodules each independently having a shape the outer surface of which meets the longitudinal axis of one or more star-shaped microfiber strands at a relatively steep angle to facilitate dislodging and removing unwanted particles both on the surface of teeth and lodged between adjacent teeth.

The present invention provides a dental flossing apparatus. The dental flossing apparatus includes: one or more star-shaped microfiber dental floss strands, wherein the one or more star-shaped microfiber dental floss strands each independently include one or more star-shaped microfiber yarns; two or more nodules coupled to and equally spaced along the one or more star-shaped microfiber dental floss strands, wherein two or more nodules are each independently coupled to each of the one or more star-shaped microfiber strands by having the one or more star-shaped microfiber strands extend through a cavity in the two or more nodules, and with the proviso that the one or more nodules are not of a size and shape that minimizes the possibility of damaging the gums of a user of the dental flossing apparatus, and the one or more nodules each independently having a shape the outer surface of which meets the longitudinal axis of one or more star-shaped microfiber strands at a relatively steep angle to facilitate dislodging and removing unwanted particles both on the surface of teeth and lodged between adjacent teeth.

The present invention provides a dental flossing apparatus. The dental flossing apparatus includes: one or more star-shaped microfiber dental floss strands, wherein the one or more star-shaped microfiber dental floss strands each independently include one or more star-shaped microfiber yarns, wherein the one or more star-shaped microfiber yarns each independently include one or more therapeutic agents; two or more nodules coupled to and equally spaced along the one or more star-shaped microfiber dental floss strands, wherein the two or more nodules are spaced at least three inches apart along the one or more star-shaped microfiber dental floss strands, wherein two or more nodules are each independently coupled to each of the one or more star-shaped microfiber strands by having the one or more star-shaped microfiber strands extend through a cavity in the two or more nodules, and with the proviso that the one or more nodules are not of a size and shape that minimizes the possibility of damaging the gums of a user of the dental flossing apparatus, and the one or more nodules each independently having a shape the outer surface of which meets the longitudinal axis of one or more star-shaped microfiber strands at a relatively steep angle to facilitate dislodging and removing unwanted particles both on the surface of teeth and lodged between adjacent teeth.

The present invention provides a spool of dental flossing apparatus. The spool of dental flossing apparatus includes: one or more star-shaped microfiber dental floss strands; and two or more nodules coupled to and spaced along the one or more star-shaped microfiber dental floss strands. In one embodiment, two or more nodules each independently coupled at equal distances along the one or more star-shaped microfiber strands.

The present invention provides a spool of dental flossing apparatus. The spool of dental flossing apparatus includes: one or more star-shaped microfiber dental floss strands, wherein the one or more star-shaped microfiber dental floss strands each independently include one or more star-shaped microfiber yarns; and two or more nodules coupled to and equally spaced along the one or more star-shaped microfiber dental floss strands, wherein two or more nodules are each independently coupled to each of the one or more star-shaped microfiber strands by having the one or more star-shaped microfiber strands extend through a cavity in the two or more nodules, and with the proviso that the one or more nodules are not of a size and shape that minimizes the possibility of damaging the gains of a user of the dental flossing apparatus, and the one or more nodules each independently having a shape the outer surface of which meets the longitudinal axis of one or more star-shaped microfiber strands at a relatively steep angle to facilitate dislodging and removing unwanted particles both on the surface of teeth and lodged between adjacent teeth.

The present invention provides a spool of dental flossing apparatus. The spool of dental flossing apparatus includes: one or more star-shaped microfiber dental floss strands, wherein the one or more star-shaped microfiber dental floss strands each independently include one or more star-shaped microfiber yarns, wherein the one or more star-shaped microfiber yarns each independently include one or more therapeutic agents; and two or more nodules coupled to and equally spaced along the one or more star-shaped microfiber dental floss strands, wherein two or more nodules are each independently coupled to each of the one or more star-shaped microfiber strands by having the one or more star-shaped microfiber strands extend through a cavity in the two or more nodules, and with the proviso that the one or more nodules are not of a size and shape that minimizes the possibility of damaging the gums of a user of the dental flossing apparatus, and the one or more nodules each independently having a shape the outer surface of which meets the longitudinal axis of one or more star-shaped microfiber strands at a relatively steep angle to facilitate dislodging and removing unwanted particles both on the surface of teeth and lodged between adjacent teeth.

The present invention provides a method of manufacturing a dental flossing apparatus. The method includes: providing one or more star-shaped microfiber strands; and coupling two or more nodules to the one or more star-shaped microfiber strands.

In one embodiment, the two or more nodules are coupled at equal intervals along the one or more star-shaped microfiber strands. In one embodiment, the two or more nodules are hot-melt coupled to the one or more star-shaped microfiber strands.

The present invention provides a method of manufacturing a dental flossing apparatus on a card stock. The method includes: providing a multi-faced rotatable block having two or more slots perpendicular to each face; providing one or more pre-slotted cards each having a proximal slot on the proximal end and a distal slot on the distal end; providing a spool of dental flossing apparatus including: one or more star-shaped microfiber dental floss strands; and two or more nodules coupled to and spaced along the one or more star-shaped microfiber dental floss strands; inserting the proximal end of each of the one or more pre-slotted cards into a first slot on each face and insert the distal end of each of the one or more pre-slotted cards into a second slot on each face; inserting one nodule into the first slot of one of the pre-slotted cards; rotating the multi-faced rotatable block so that the spool of dental flossing apparatus is laid out across the one or more pre-slotted cards; and cutting the dental floss between the one or more pre-slotted cards.

The present invention provides a method of flossing the teeth of a mammal. The method includes: providing a dental flossing apparatus including: one or more star-shaped microfiber dental floss strands; and two or more nodules coupled to and spaced along the one or more star-shaped microfiber dental floss strands; grasping the dental flossing apparatus at the two or more nodules; stretching the one or more star-shaped microfiber strands between the two or more nodules; inserting the one or more star-shaped microfiber strands between two teeth; and moving the one or more star-shaped microfiber strands between the two teeth.

The present invention provides a method of applying a therapeutic agent to the teeth of a mammal. The method includes: providing a dental flossing apparatus including: one or more star-shaped microfiber dental floss strands; and two or more nodules coupled to and spaced along the one or more star-shaped microfiber dental floss strands; adding one or more therapeutic agents to the one or more star-shaped microfiber strands; grasping the dental flossing apparatus at the two or more nodules; stretching the one or more star-shaped microfiber strands between the two or more nodules; inserting the one or more star-shaped microfiber strands between two teeth; contacting the two teeth with the one or more star-shaped microfiber strands; and moving the one or more star-shaped microfiber strands between the two teeth.

The present invention provides a kit. The kit includes: one or more therapeutic agents; and a dental flossing apparatus including: one or more star-shaped microfiber dental floss strands; two or more nodules coupled to and spaced along the one or more star-shaped microfiber dental floss strands, and one or more therapeutic agents.

### BRIEF DESCRIPTION OF THE DRAWINGS

Embodiments of the invention may be best understood by referring to the following description and accompanying drawings, which illustrate such embodiments. In the drawings:

FIG. 1 illustrates a segment of the exemplary dental flossing apparatus.

FIG. 2 illustrates a strand of the exemplary dental flossing apparatus.

FIGS. 3-4 are digital photographs of a segment of the exemplary one or more star-shaped microfiber dental floss strands.

FIG. 5 is a digital photograph of an exemplary nodule that contains a cavity.

FIG. 6 is a block diagram illustrating an exemplary method of flossing the teeth of a mammal.

FIG. 7 is a block diagram illustrating an exemplary method of applying a therapeutic agent to the dental flossing apparatus.

FIG. 8 is a block diagram illustrating an exemplary method of applying a therapeutic agent to the teeth of a mammal.

FIG. 9 is a block diagram illustrating an exemplary method of manufacturing a dental flossing apparatus.

FIG. 10 is a block diagram further illustrating an exemplary method of manufacturing a dental flossing apparatus.

FIG. 11 is a block diagram illustrating an exemplary method of manufacturing a dental flossing apparatus on a card stock.

FIG. 12 illustrates an exemplary kit that contains a segment of dental flossing apparatus and a therapeutic agent.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides a dental flossing apparatus that includes one or more star-shaped microfiber stands with two nodules and one or more optional therapeutic agents. Method of using the dental flossing apparatus to deliver one or more optional therapeutic agents to the teeth and gums are also provided.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), o the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the present invention is not entitled to antedate such material by virtue of prior invention.

Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “administration” refers to a method of placing a device to a desired site.

As used herein, the term “and/or” refers to any one of the items, any combination of the items, or all of the items with which this term is associated.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “comprising” or “comprises” is intended to mean that the compositions and methods include the recited elements, but not excluding others.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the term “delivery” refers to the release of a drug from a device comprising that drug into an environment surrounding the device.

As used herein, the term “an effective amount” refers to an amount sufficient to effect beneficial or desired results. An effective amount can be administered in one or more administrations, applications, or dosages. Determination of an effective amount for a given administration is well within the ordinary skill in the pharmaceutical arts.

As used herein, the term “essential oil” refers to a volatile oil derived from the leaves, stem, flower or twigs of plants or synthetically-made compounds that have the same chemical attributes. The essential oil usually carries the odor or flavor of the plant. Chemically, each plant essential oil or derivative thereof, which may be extracted from natural sources or synthetically made, generally contains, as a major constituent, an acyclic monoterpene alcohol or aldehyde, a benzenoid aromatic compound containing at least one oxygenated substituent or side chain, or a monocarbocyclic terpene generally having a six-membered ring bearing one or more oxygenated substituents.

As used herein, the term “essential oil” includes derivatives thereof, including racemic mixtures, enantiomers, diastereomers, hydrates, salts, solvates, metabolites, analogs, and homologs

One or more essential oils, their chemistry and plant families are known in the art. See, for example, S. Price, Aromatherapy Workbook—Understanding One or more essential oils from Plant to Bottle, (HarperCollins Publishers, 1993; J. Rose, The Aromatherapy Book—Applications & Inhalations (North Atlantic Books, 1992); and The Merck Index (12th Ed. 1996), each of which is incorporated herein by reference.

As used herein, the term “immersing” refers to dipping, plunging, or sinking into a liquid.

As used herein, the terms “include,” “for example,” “such as,” and the like are used illustratively and are not intended to limit the present invention.

As used herein, the terms “individual,” “host,” “subject,” and “patient” are used interchangeably, and refer to a mammal, including, but not limited to, primates, including simians and humans.

As used herein, the term “microfiber yarns” refer yarns made of microfiber strands. Typical microfiber yarns include, for example, polyester and polyamide composite yarn composed of Nylon 6 and Polyester with a minimum count per filament of about 0.13Dtex.

As used herein, the term “mammal” refers o any of a class of warm-blooded higher vertebrates that nourish their young with milk secreted by mammary glands and have skin usually more or less covered with hair, and non-exclusively includes humans and non-human primates, their children, including neonates and adolescents, both male and female, livestock species, such as horses, cattle, sheep, and goats, and research and domestic species, including dogs, cats, mice, rats, guinea pigs, and rabbits.

As used herein, the terms “optional” or “optionally” mean that the subsequently described event or condition may but need not occur, and that the description includes instances where the event or condition occurs and instances in which it does not.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “therapeutic agent” refers to any agent, which serves to repair damage to a living organism to heal the organism, to cure a malcondition, to combat an infection by a microorganism or a virus, to assist the body of the living mammal to return to a healthy state.

As used herein, the term “therapeutically effective amount” is intended to include an amount of a compound described herein, or an amount of the combination of compounds described herein, e.g., to treat or prevent the disease or disorder, or to treat the symptoms of the disease or disorder, in a host. The combination of compounds is preferably a synergistic combination. Synergy, as described for example by Chou and Talalay, Adv. Enzyme Regul., 22:27 (1984), occurs when the effect of the compounds when administered in combination is greater than the additive effect of the compounds when administered alone as a single agent. In general, a synergistic effect is most clearly demonstrated at suboptimal concentrations of the compounds. Synergy can be in terms of lower cytotoxicity, increased activity, or some other beneficial effect of the combination compared with the individual components.

As used herein, the terms “therapy,” and “therapeutic” refer to either “treatment” or “prevention,” thus, agents that either treat damage or prevent damage are “therapeutic.”

As used herein, the terms “treating” or “treat” or “treatment” refer to obtaining a desired pharmacologic and/or physiologic effect. The effect may be prophylactic in terms of completely or partially preventing a disease or symptom thereof and/or may be therapeutic in terms of a partial or complete cure for a disease and/or adverse affect attributable to the disease.

As used herein, the term “treatment,” covers any treatment of a disease in a mammal, particularly in a human, and includes: (a) preventing the disease from occurring in a subject which may be predisposed to the disease but has not yet been diagnosed as having it; (b) inhibiting the disease, i.e., arresting its development; and (c) relieving the disease, i.e., causing regression of the disease.

As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to limit the element which they describe, as the various elements may be oriented differently in various applications.

It will be understood that although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

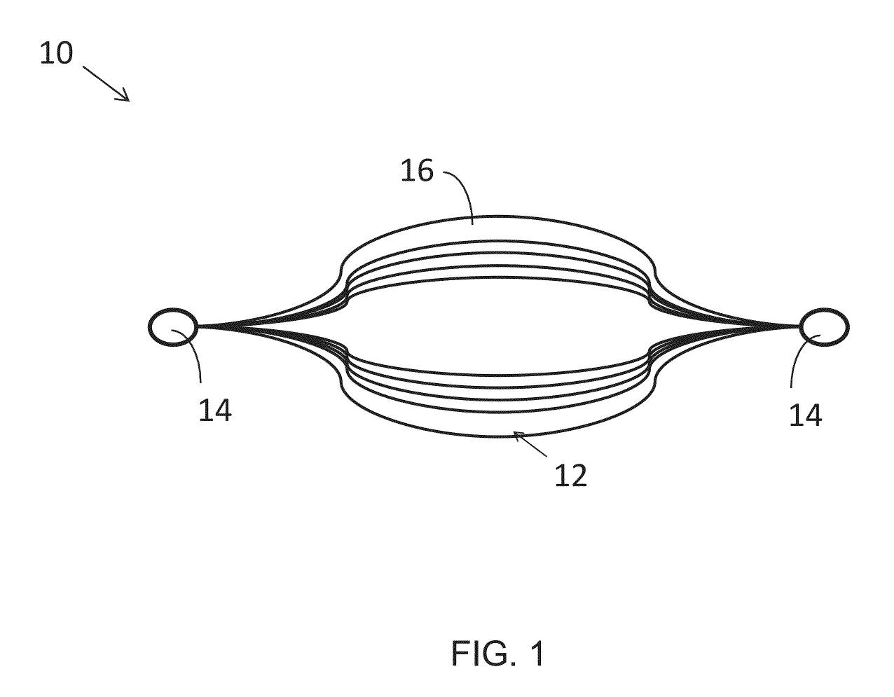

FIG. 1 illustrates a segment of the exemplary dental flossing apparatus 10 including one or more star-shaped microfiber dental floss strands 12 and two or more nodules 14 coupled to and spaced along the one or more star-shaped microfiber dental floss strands 12.

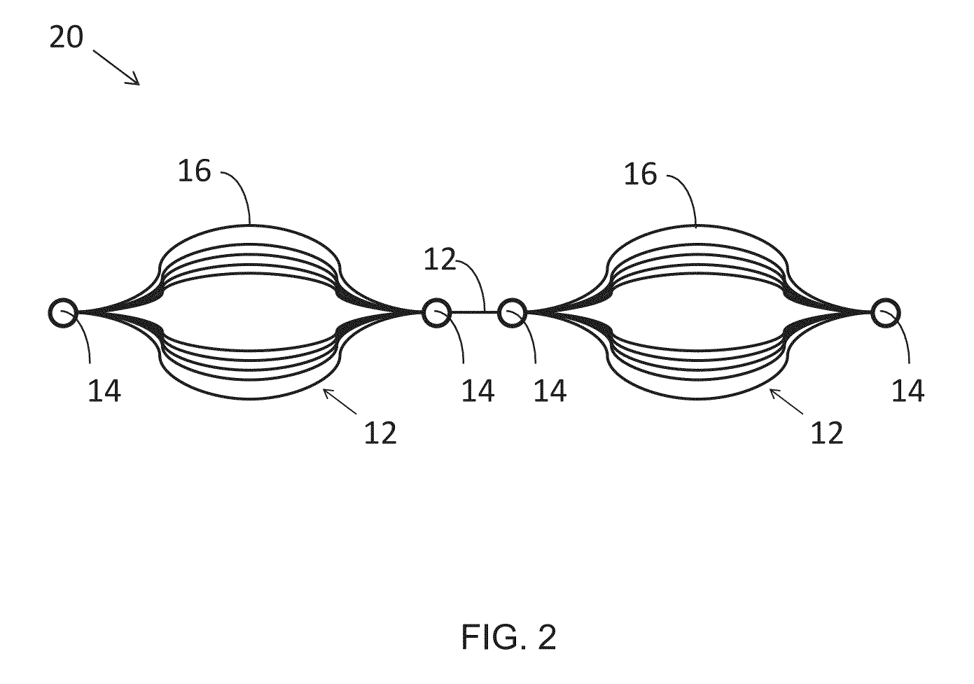

FIG. 2 illustrates a strand 20 including two of the exemplary dental flossing apparatus 10 including one or more star-shaped microfiber dental floss strands 12 and two or more nodules 14 coupled to and spaced along the one or more star-shaped microfiber dental floss strands 12. In the strand, the two or more nodules 14 are in pairs along the one or more star-shaped micro fiber dental floss strands 12. This allows for the user to cut the one or more star-shaped microfiber dental floss strands 12 between the pair of the two or more nodules 14 to provide the dental flossing apparatus 10. In one embodiment, the two or more nodules 14 are spaced at least six inches apart along the one or more star-shaped microfiber dental floss strands 12. In one embodiment, the two or more nodules 14 are spaced at least three inches apart along the one or more star-shaped microfiber dental floss strands 12.

In one embodiment, and the one or more nodules 14 are not of a size and shape that minimizes the possibility of damaging the gums of a user of the dental flossing apparatus 10, and the one or more nodules 14 each independently having a shape the outer surface of which meets the longitudinal axis of one or more star-shaped microfiber strands 12 at a relatively steep angle to facilitate dislodging and removing unwanted particles both on the surface of teeth and lodged between adjacent teeth.

In one embodiment, the one or more star-shaped microfiber dental floss strands 12 each independently include one or more star-shaped microfiber yarns 16. In one embodiment, the one or more star-shaped microfiber dental floss strands 12 each independently include a polyester polyamide fiber.

In one embodiment, the two or more nodules 14 are equally spaced along the one or more star-shaped microfiber dental floss strands 12. In one embodiment, the two or more nodules 14 are spaced at least six inches apart along the one or more star-shaped microfiber dental floss strands 12. In one embodiment, the two or more nodules 14 assist with winding up of the one or more star-shaped microfiber dental floss strands 12 on to a spool. In one embodiment, the one or more star-shaped microfiber dental floss strands each independently have a thickness from about 50D/436F*16 to about 320D/144F*16. Typically, the star-shaped microfiber dental floss strands 12 should have the range should be: PN80/20DTY 75D/36F through PN80/20DTY 480D/216F, preferably PN80/20DTY 75D/36F, PN80/20DTY160D/72F, PN80/20DTY 320D/144F, or PN80/20DTY 480D/216F, wherein the PN80/20DTY is 80/20% Polyester to Nylon. The other numbers are thickness and the like.

In one embodiment, the diameter of the two or more nodules 14 is from about 0.5 mm to about 8.0 mm. In one embodiment, the diameter of the two or more nodules 14 is from about 2 mm to about 6 mm. In one embodiment, the two or more nodules 14 are each independently spherically-shaped, elliptically-shaped, square-shaped, star-shaped, rectangular-shaped, triangularly-shaped, irregularly-shaped, or a combination thereof.

In one embodiment, the two or more nodules 14 are each independently coupled to each of the one or more star-shaped microfiber strands 12 by having the one or more star-shaped microfiber strands 12 extend through a cavity (not shown) in the two or more nodules 14.

In one embodiment, the two or more nodules 14 are each independently hot-melted to the one or more star-shaped microfiber strands 12. In one embodiment, the two or more nodules 14 are each independently glued to the one or more star-shaped microfiber strands 12.

In one embodiment, the two or more nodules 14 each independently include a plastic, a wax, a metal, a wood, a composite material, or a combination thereof. In one embodiment, the plastic includes a polylactic acid.

In one embodiment, the one or more star-shaped microfiber dental floss strands 12 each independently further include one or more therapeutic agents (not shown). In one embodiment, the one or more therapeutic agents each independently include hydrogen peroxide, tea tree oil, one or more probiotic gum oils, one or more essential oils, chlorhexidine gluconate, or a combination thereof.

In one embodiment, a spool of the dental flossing apparatus 10 can be made by wrapping the dental flossing apparatus 10 around a spool (not shown).

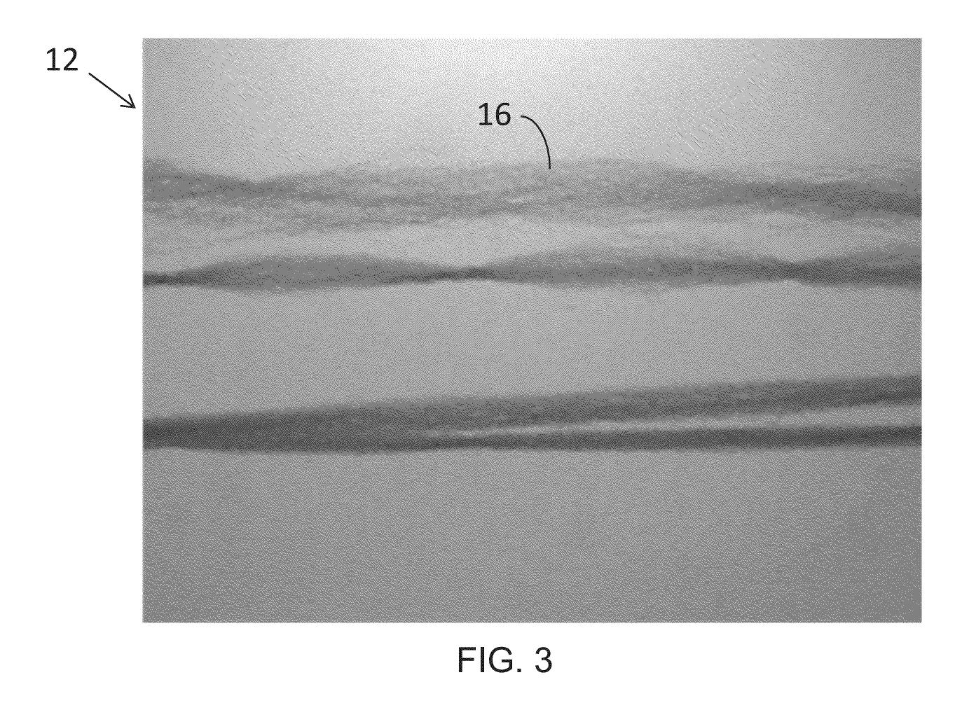

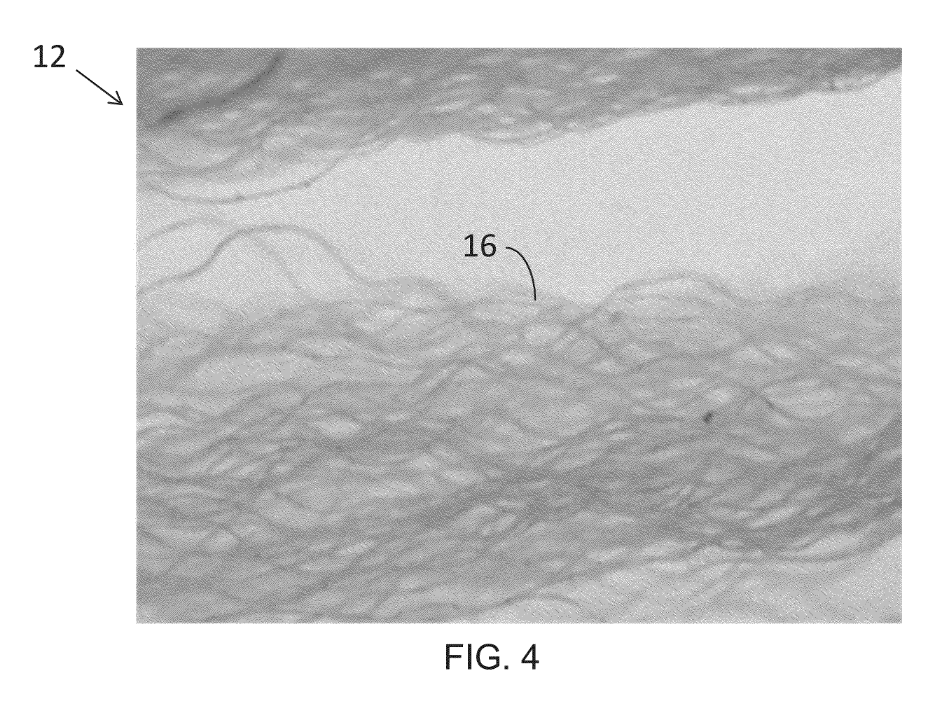

FIGS. 3-4 are digital photographs of a segment of the exemplary one or more star-shaped microfiber dental floss strands 12 that include one or more star-shaped microfiber yarns 16.

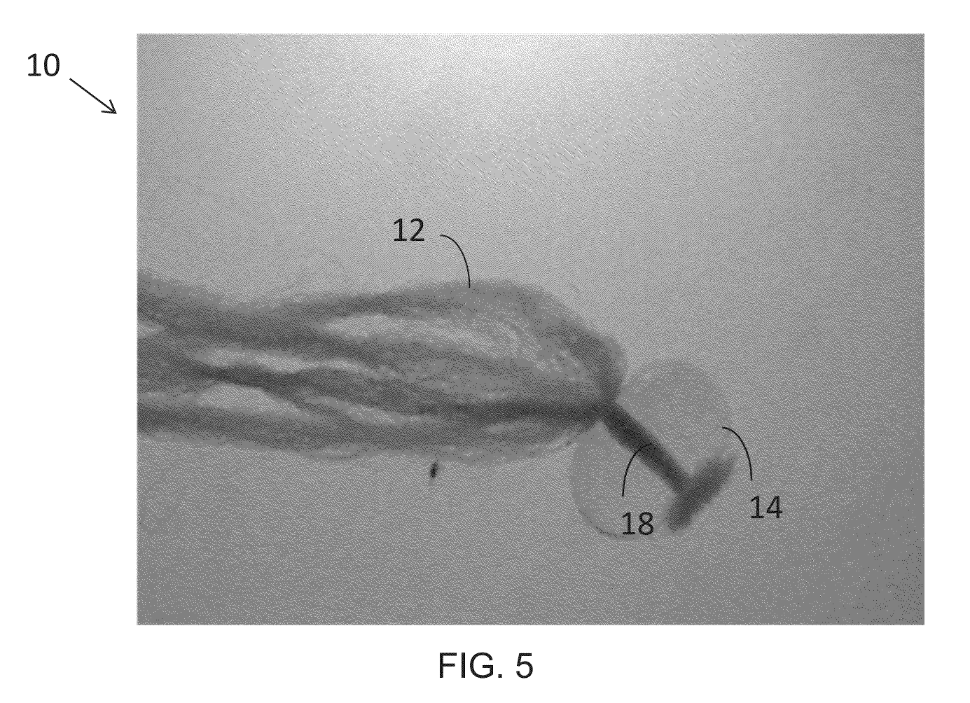

FIG. 5 is a digital photograph of an exemplary nodule 14 that contains a cavity 18 in which the one or more star-shaped microfiber dental floss strands 12 are contained therein.

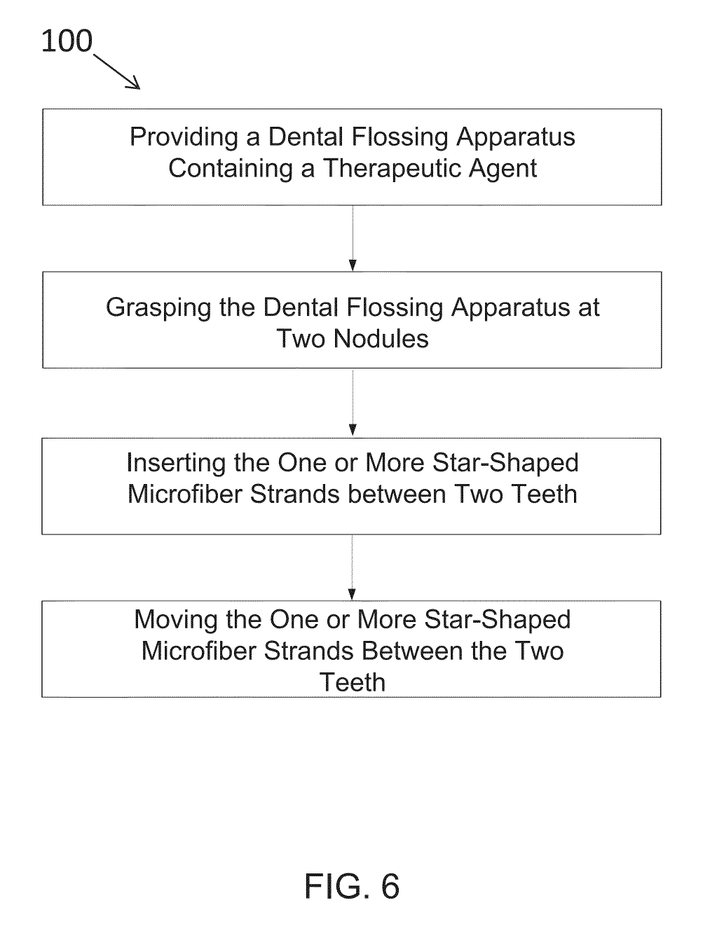

FIG. 6 is a block diagram illustrating an exemplary method 100 of flossing the teeth of a mammal. The method includes: providing a dental flossing apparatus 10 including: one or more star-shaped microfiber dental floss strands 12; and two or more nodules 14 coupled to and spaced along the one or more star-shaped microfiber dental floss strands 12; grasping the dental flossing apparatus at the two or more nodules 14; optionally stretching the one or more star-shaped microfiber strands 12 between the two or more nodules 14; inserting the one or more star-shaped microfiber strands 12 between two teeth; and moving the one or more star-shaped microfiber strands 12 between the two teeth.

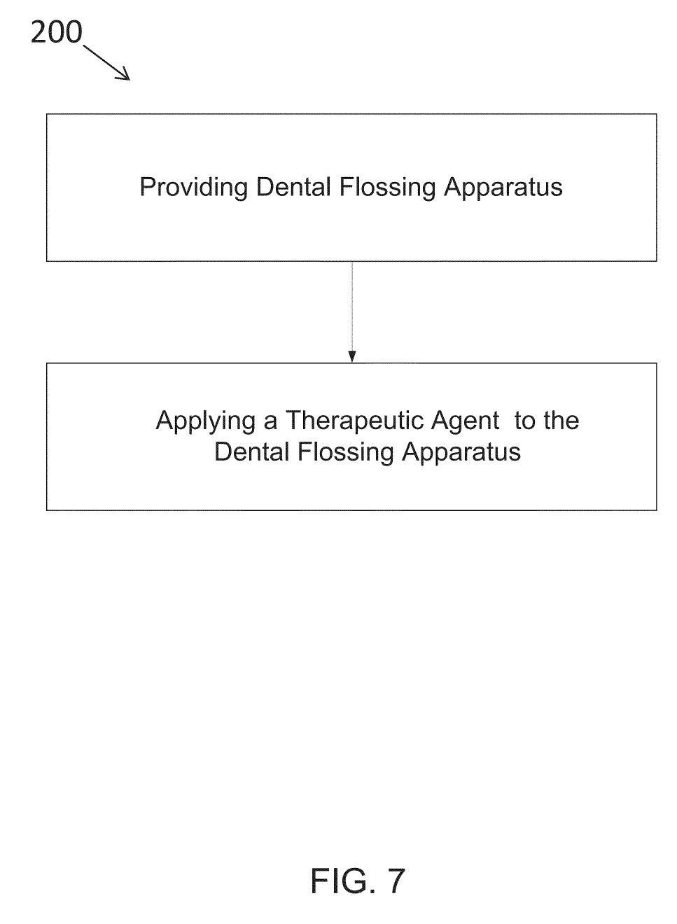

FIG. 7 is a block diagram illustrating an exemplary method 200 of applying a therapeutic agent to the dental flossing apparatus 10. The method includes: providing the dental flossing apparatus 10 and applying a therapeutic agent to the dental flossing apparatus 10.

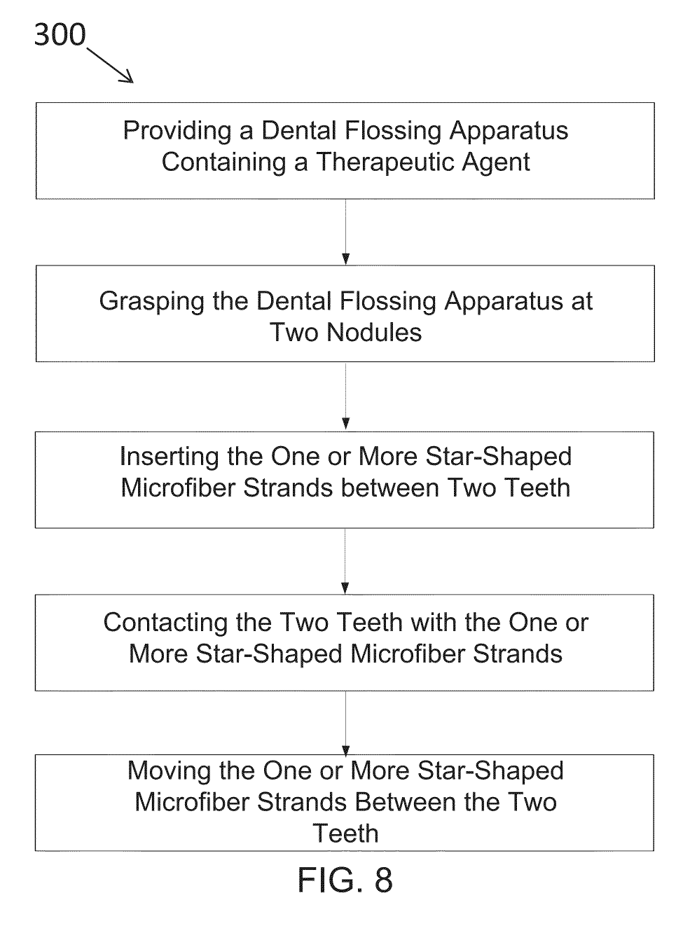

FIG. 8 is a block diagram illustrating an exemplary method 300 of applying a therapeutic agent to the teeth of a mammal. The method includes: providing a dental flossing apparatus 10 including: one or more star-shaped microfiber dental floss strands 12; and two or more nodules 14 coupled to and spaced along the one or more star-shaped microfiber dental floss strands 12; adding one or more therapeutic agents to the one or more star-shaped microfiber strands 12; grasping the dental flossing apparatus 10 at the two or more nodules 14; optionally stretching the one or more star-shaped microfiber strands 12 between the two or more nodules 14; inserting the one or more star-shaped microfiber strands 12 between two teeth; contacting the two teeth with the one or more star-shaped microfiber strands 12; and moving the one or more star-shaped microfiber strands 12 between the two teeth.

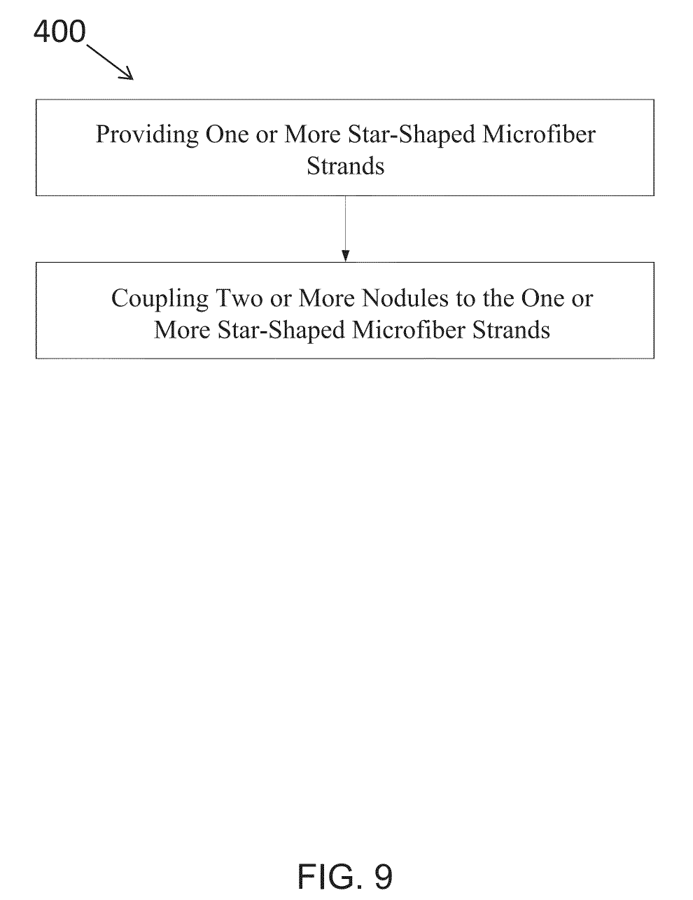

FIG. 9 is a block diagram illustrating an exemplary method 400 of manufacturing a dental flossing apparatus 10. The method includes: providing one or more star-shaped microfiber strands 12; and coupling two or more nodules 14 to the one or more star-shaped microfiber strands 12. In one embodiment, the two or more nodules 14 are hot-melt coupled to the one or more star-shaped microfiber strands 12.

In one embodiment, the two or more nodules 14 are each independently glued coupled to the one or more star-shaped microfiber strands 12.

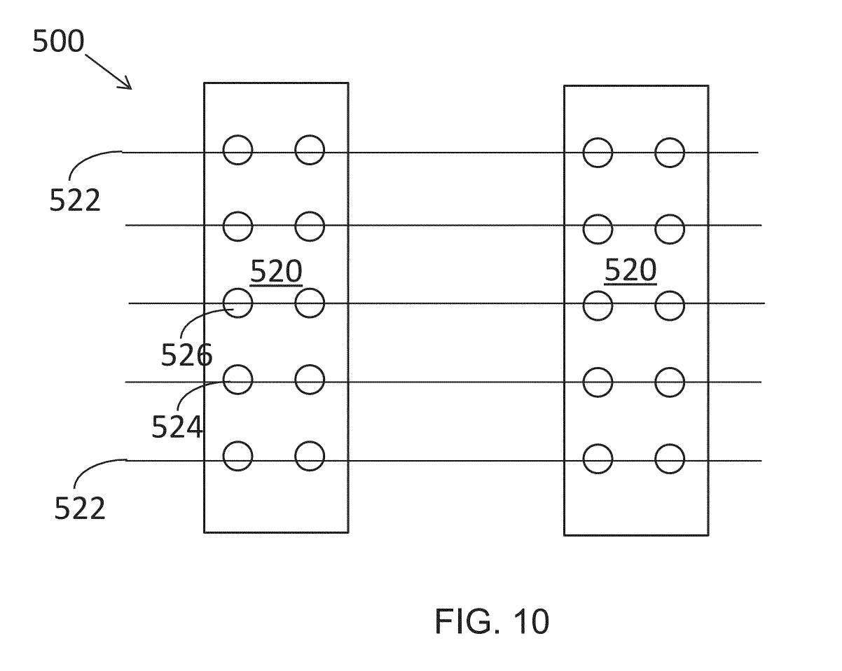

FIG. 10 is a block diagram further illustrating an exemplary method 500 of manufacturing a dental flossing apparatus 10. In one embodiment, two plates 520 are aligned and fastened to a fixture (not shown). The one or more star-shaped microfiber strands 522 are strung continuously through the grooves 524 in the plate 520. Once the one or more star-shaped microfiber strands 522 are in place, hot wax (beeswax/carnauba) or PLA (cornstarch based plastic) is added to the Teflon coated wells 526. Once this material cools, the one or more star-shaped microfiber strands 522, with nodules (not shown) attached are removed from the plate 520 for packaging on card stock or on spools.

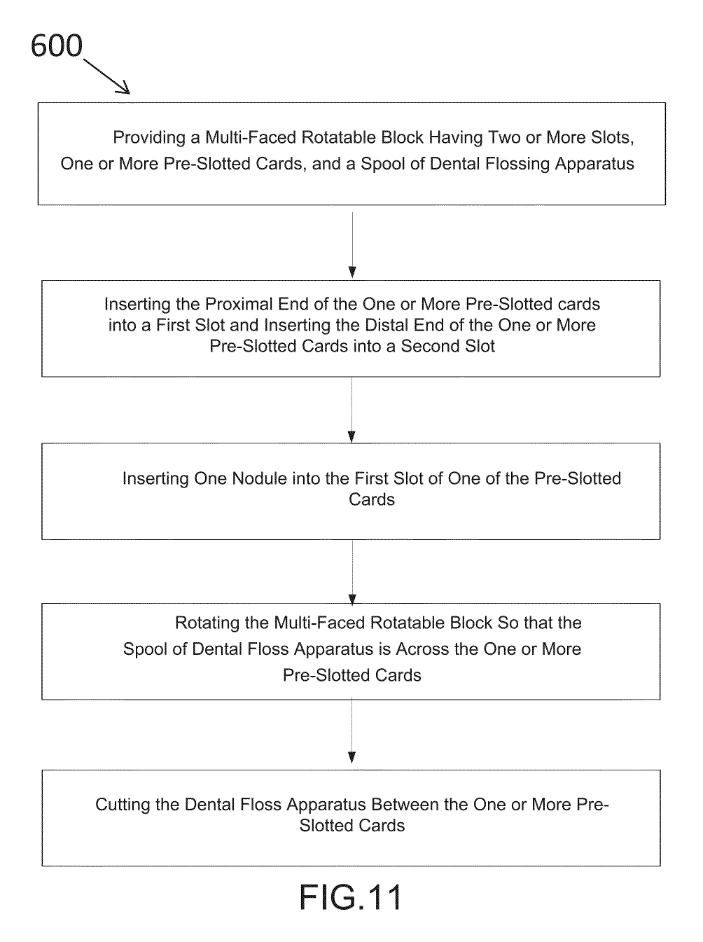

FIG. 11 is a block diagram illustrating an exemplary method 600 of manufacturing a dental flossing apparatus 10 on a card stock. The method includes: providing a multi-faced rotatable block having two or more slots perpendicular to each face; providing one or more pre-slotted cards each having a proximal slot on the proximal end and a distal slot on the distal end; providing a spool of dental floss apparatus 10 including: one or more star-shaped microfiber dental floss strands 12; and two or more nodules 14 coupled to and spaced along the one or more star-shaped microfiber dental floss strands 12; inserting the proximal end of each of the one or more pre-slotted cards into a first slot on each face and insert the distal end of each of the one or more pre-slotted cards into a second slot on each face; inserting one nodule into the first slot of one of the pre-slotted cards; rotating the multi-faced rotatable block so that the spool of dental floss apparatus is laid out across the one or more pre-slotted cards; and cutting the dental floss apparatus between the one or more pre-slotted cards.

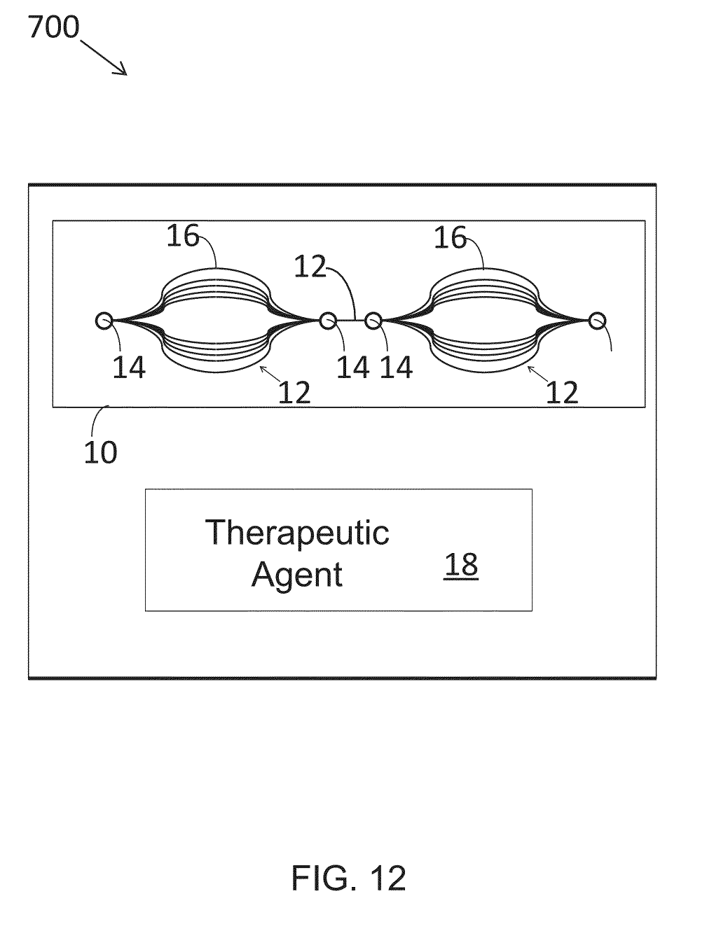

FIG. 12 illustrates an exemplary kit 700 that contains a segment of dental flossing apparatus 10 and a therapeutic agent 18.

The invention should now be illustrated with the following non-limiting examples.

### EXAMPLE 1

### Preparation of Dental Flossing Apparatus Including a Therapeutic Agent

A strand of dental flossing apparatus was held between two hands by a user. The star-shaped microfiber dental floss strands were dipped into a 3% solution of hydrogen peroxide (available from Walgreens, Deerfield, Ill.) until the star-shaped microfiber dental floss strands were saturated. The user contacted the hydrogen peroxide saturated star-shaped micro fiber dental floss strands to the user's teeth and gums, and moved the hydrogen peroxide saturated star-shaped microfiber dental floss strands between the teeth.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

In the claims provided herein, the steps specified to be taken in a claimed method or process may be carried out in any order without departing from the principles of the invention, except when a temporal or operational sequence is explicitly defined by claim language. Recitation in a claim to the effect that first a step is performed several other steps are performed shall be taken to mean that the first step is performed before any of the other steps, but the other steps may be performed in any sequence unless a sequence is further specified within the other steps. For example, claim elements that recite “first A, B, C, and D, and lastly E” shall be construed to mean step A must be first, step E must be last, but steps B, C, and D may be carried out in any sequence between steps A and E and the process of that sequence will still fall within the four corners of the claim.

Furthermore, in the claims provided herein, specified steps may be carried out concurrently unless explicit claim language requires that they be carried out separately or as parts of different processing operations. For example, a claimed step of doing X and a claimed step of doing Y may be conducted simultaneously within a single operation, and the resulting process will be covered by the claim. Thus, a step of doing X, a step of doing Y, and a step of doing Z may be conducted simultaneously within a single process step, or in two separate process steps, or in three separate process steps, and that process will still fall within the four corners of a claim that recites those three steps.

Similarly, except as explicitly required by claim language, a single substance or component may meet more than a single functional requirement, provided that the single substance or component fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention.

Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to above including but not limited to any original claims.

What is claimed is:

1. A dental flossing apparatus comprising:
one or more star-shaped microfiber dental floss strands; and
two or more nodules coupled to and spaced along the one or more star-shaped microfiber dental floss strands.

2. The dental floss apparatus of claim 1, wherein the one or more star-shaped microfiber dental floss strands each independently comprise one or more star-shaped microfiber yarns.

3. The dental floss apparatus of claim 1, wherein the one or more star-shaped microfiber dental floss strands each independently comprise a polyester polyamide fiber.

4. The dental floss apparatus of claim 1, wherein the two or more nodules are equally spaced along the one or more star-shaped microfiber dental floss strands.

5. The dental floss apparatus of claim 1, wherein the two or more nodules are spaced at least three inches apart along the one or more star-shaped microfiber dental floss strands.

6. The dental floss apparatus of claim 1, wherein a diameter of the two or more nodules is from about 0.5 mm to about 8.0 mm.

7. The dental floss apparatus of claim 1, wherein the two or more nodules are each independently spherically-shaped, elliptically-shaped, square-shaped, star-shaped, rectangular-shaped, triangularly-shaped, irregularly-shaped, or a combination thereof.

8. The dental floss apparatus of claim 1, wherein the two or more nodules are each independently coupled to each of the one or more star-shaped microfiber strands by having the one or more star-shaped microfiber strands extend through a cavity in the two or more nodules.

9. The dental floss apparatus of claim 1, wherein the two or more nodules are each independently hot-melted to the one or more star-shaped microfiber strands.

10. The dental floss apparatus of claim 1, wherein the two or more nodules are each independently glued to the one or more star-shaped microfiber strands.

11. The dental floss apparatus of claim 1, wherein the two or more nodules each independently comprise a plastic, a wax, a metal, a wood, a composite material, or a combination thereof.

12. The dental floss apparatus of claim 11, wherein the plastic comprises a polylactic acid.

13. The dental floss apparatus of claim 1, wherein the one or more star-shaped microfiber dental floss strands each independently further comprise one or more therapeutic agents.

14. The dental floss apparatus of claim 13, wherein the one or more therapeutic agents each independently comprise hydrogen peroxide, tea tree oil, one or more probiotic gum oils, one or more essential oils, chlorhexidine gluconate, or a combination thereof.

15. A dental floss apparatus comprising:
one or more star-shaped microfiber dental floss strands,
wherein the one or more star-shaped microfiber dental floss strands each independently comprise one or more star-shaped microfiber yarns;
two or more nodules coupled to and equally spaced along the one or more star-shaped microfiber dental floss strands,
wherein two or more nodules are each independently coupled to each of the one or more star-shaped microfiber strands by haying the one or more star-shaped microfiber strands extend through a cavity in the two or more nodules, and
with the proviso that the one or more nodules are not of a size and a shape that minimizes the possibility of damaging the gums of a user of the dental flossing apparatus, and the one or more nodules each independently having a shape an outer surface of which meets the longitudinal axis of one or more star-shaped microfiber strands at a relatively steep angle to facilitate dislodging and removing unwanted particles both on the surface of teeth and lodged between adjacent teeth.

16. The dental floss apparatus of claim 15, wherein the two or more nodules each independently comprise a plastic, a wax, a metal, a wood, a composite material, or a combination thereof.

17. The dental floss apparatus of claim 15, wherein the one or more star-shaped microfiber dental floss strands each independently further comprise one or more therapeutic agents.

18. The dental floss apparatus of claim 17, wherein the one or more therapeutic agents each independently comprise hydrogen peroxide, tea tree oil, one or more probiotic gum oils, one or more essential oils, chlorhexidine gluconate, or a combination thereof.

19. A dental flossing apparatus comprising:
one or more star-shaped microfiber dental floss strands,
wherein the one or more star-shaped microfiber dental floss strands each independently comprise one or more star-shaped microfiber yarns,
wherein the one or more star-shaped microfiber yarns each independently comprise one or more therapeutic agents;
two or more nodules coupled to and equally spaced along the one or more star-shaped microfiber dental floss strands,
wherein the two or more nodules are spaced at least three inches apart along the one or more star-shaped microfiber dental floss strands,
wherein two or more nodules are each independently coupled to each of the one or more star-shaped microfiber strands by having the one or more star-shaped microfiber strands extend through a cavity in the two or more nodules, and with the proviso that the one or more nodules are not of a size and a shape that minimizes the possibility of damaging the gums of a user of the dental flossing apparatus, and the one or more nodules each independently having a shape an outer surface of which meets the longitudinal axis of one or more star-shaped microfiber strands at a relatively steep angle to facilitate dislodging and removing unwanted particles both on the surface of teeth and lodged between adjacent teeth.

20. The dental floss apparatus of claim 19, wherein the one or more therapeutic agents each independently comprise hydrogen peroxide, tea tree oil, one or more probiotic gum oils, one or more essential oils, chlorhexidine gluconate, or a combination thereof.
